(19) United States
(12) Patent Application Publication
(10) Pub. No.: US 2024/0195136 A1
(43) Pub. Date: Jun. 13, 2024

(54) ELECTRICAL CHARGING CONTACT BASE FOR CHARGING A VEHICLE

(71) Applicant: Conductix, Inc., Omaha, NE (US)

(72) Inventor: Jonathon D. Smith, Omaha, NE (US)

(21) Appl. No.: 18/532,124

(22) Filed: Dec. 7, 2023

Related U.S. Application Data
(60) Provisional application No. 63/431,188, filed on Dec. 8, 2022.

(51) Int. Cl. H01R 41/00

(52) U.S. Cl. CPC H01R 41/00; B60L 53/14; H01R 2201/26

(57) ABSTRACT

An electrical contact base for charging a vehicle can include an insulating base, an insulating cover connected to the insulating base, and a bus bar captured between the insulating base and the insulating cover, where the vehicle is configured to contact the electrical contact base for charging the vehicle. The bus bar can have a contact plate and an integrally connected end tab. In some embodiments, the end tab defines an incline for guiding a brush of a vehicle onto the electrical contact base and into contact with the contact plate. In some embodiments, the insulating base and the insulating cover are formed of polymer insulator material. In some embodiments, the insulating base and the insulating cover are connected by a snap-fit connection. In some embodiments, the electrical contact base defines a lattice support structure.

### CROSS-REFERENCE TO RELATED APPLICATIONS

The present application claims the benefit under 35 U.S.C. § 119(e) of U.S. Provisional Application Ser. No. 63/431,188, filed Dec. 8, 2022, and titled “ELECTRICAL CHARGING CONTACT BASE FOR CHARGING A VEHICLE,” which is herein incorporated by reference in its entirety.

### BACKGROUND

Generally, a brush is an electrical contact which conducts current between stationary wires and moving parts.

### DRAWINGS

The Detailed Description is described with reference to the accompanying figures. The use of the same reference numbers in different instances in the description and the figures may indicate similar or identical items.

FIG. 1 is an isometric view illustrating an electrical contact base for charging a vehicle in accordance with example embodiments of the present disclosure.

FIG. 2 is an exploded isometric view of the electrical contact base illustrated in FIG. 1.

FIG. 3 is another exploded isometric view of the electrical contact base illustrated in FIG. 1.

FIG. 4 is an isometric view illustrating another electrical contact base for charging a vehicle in accordance with example embodiments of the present disclosure.

FIG. 5 is an exploded isometric view of the electrical contact base illustrated in FIG. 4.

FIG. 6 is another exploded isometric view of the electrical contact base illustrated in FIG. 4.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

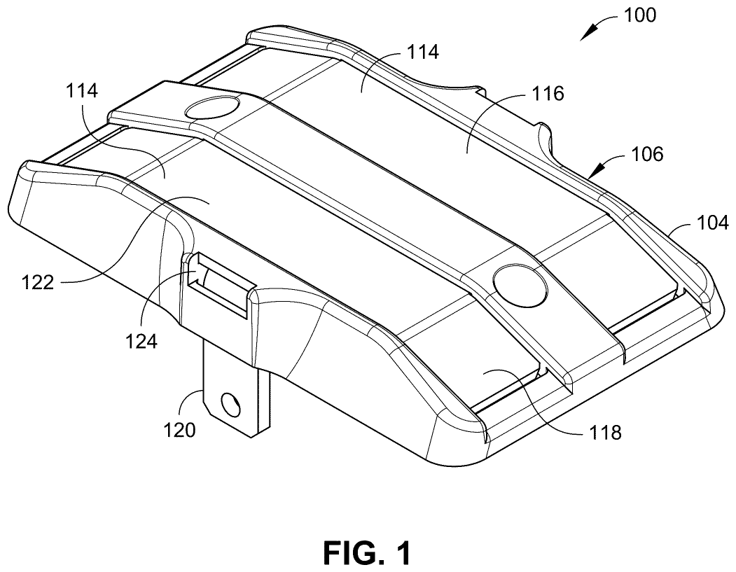

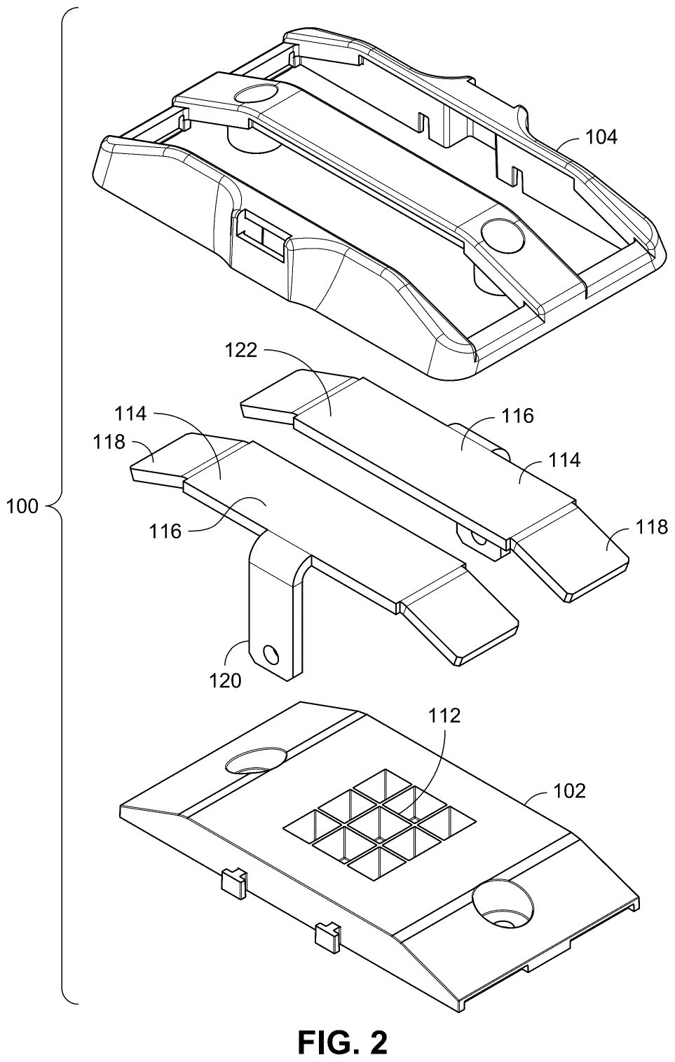

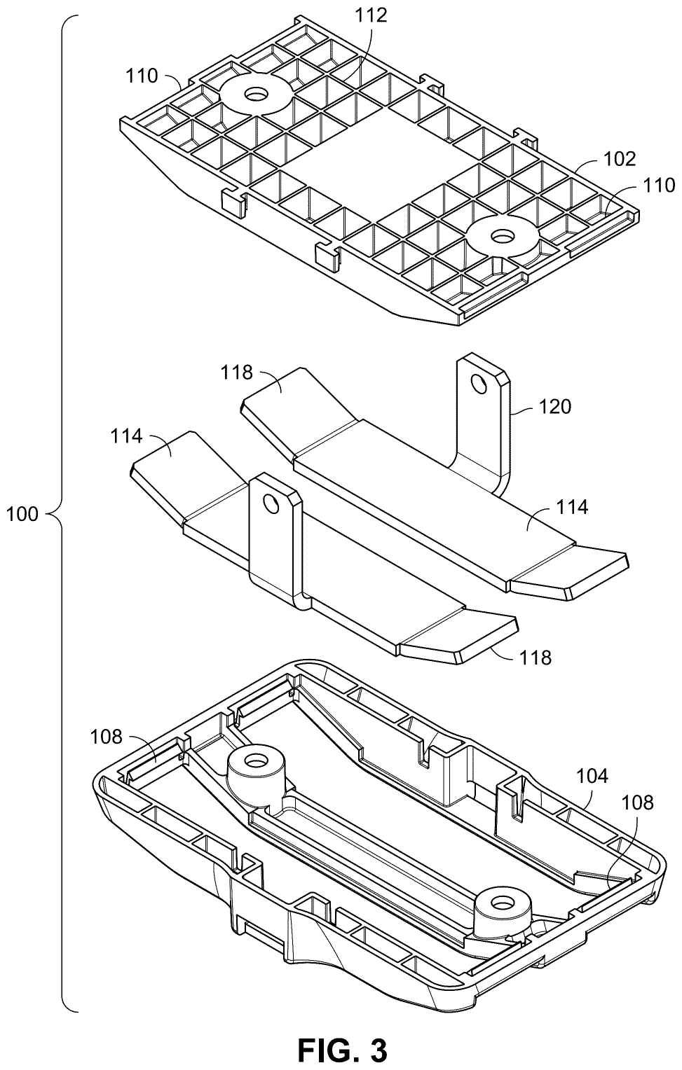

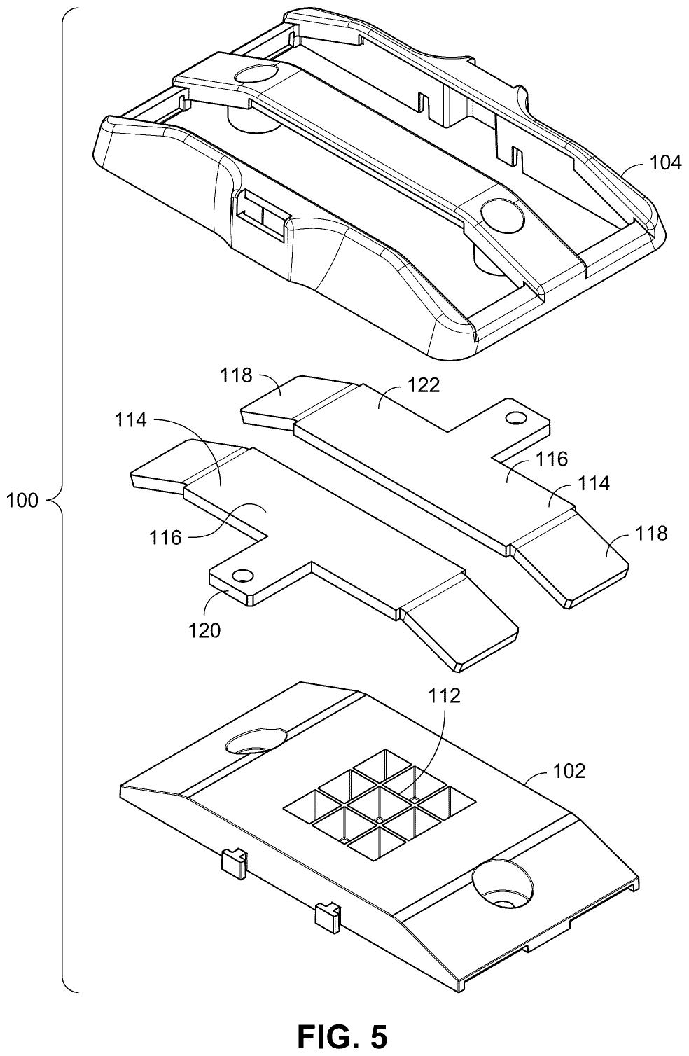

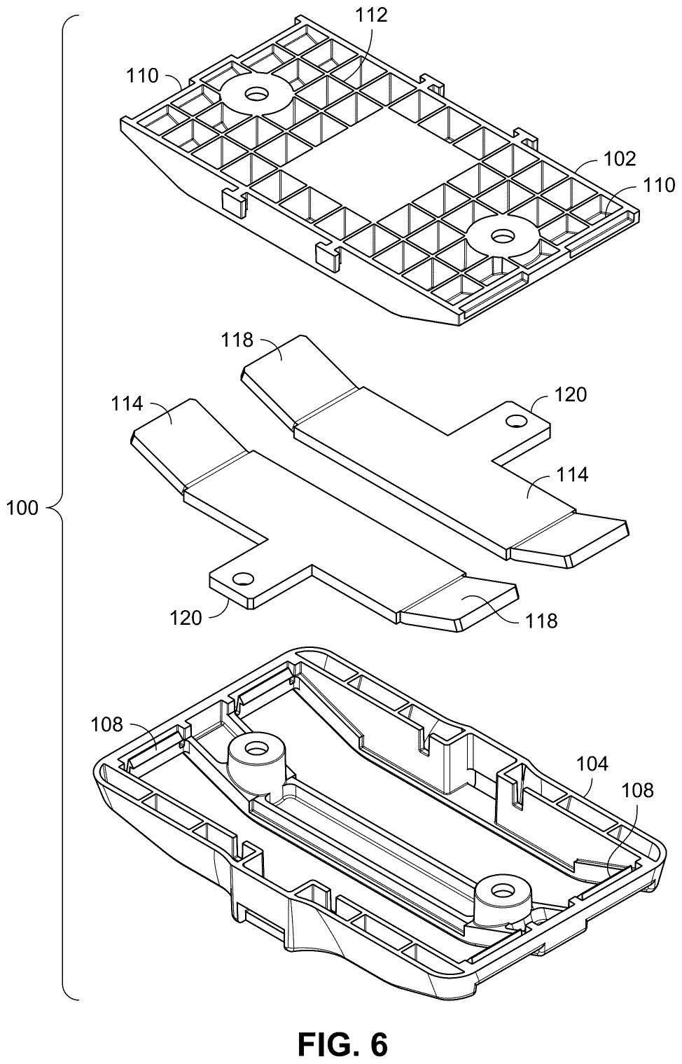

Referring generally to FIGS. 1 through 6, electrical contact bases 100 for charging a vehicle, such as a battery-powered vehicle, are described. In embodiments, an electrical contact base 100 can be used to charge a battery-powered vehicle that contacts the charging base to charge its battery, and then breaks contact with the charging base after charging the battery. For example, an electrical contact base 100 can be generally ramp-shaped, and a vehicle can have one or more contacts that are guided by the ramp shape of the charging base into contact with one or more battery charging contacts. In some embodiments, the battery-powered vehicle drives onto and/or over the electrical contact base 100 for charging and then off of the base after charging. The contacts of the electrical contact base 100 can be connected to a power source, such as a supply of electrical energy.

As described, the electrical contact base 100 includes an insulating base 102 and an insulating cover 104 connected to the insulating base 102. In embodiments, the insulating base 102 and the insulating cover 104 are formed from electrically insulating material(s), such as polymer insulator material. It should be noted that polymer insulators are provided by way of example and are not meant to limit the present disclosure. In other embodiments, the insulating base 102 and/or the insulating cover 104 can be formed from various other insulating materials. Together, the insulating base 102 and the insulating cover 104 form a shell assembly 106 that captures conductors, such as copper contact plates or bus bars, between the insulating base 102 and the insulating cover 104 forming the shell assembly 106. In embodiments, the electrical contact base 100 can be constructed without the use of fasteners, such as screws, rivets, and so forth.

In some embodiments, the insulating base 102 and the insulating cover 104 are connected by a snap-fit connection to form the shell assembly 106. In this manner, separate mechanical fastening hardware is not necessarily used during assembly of the insulating base 102 and the insulating cover 104. For example, the insulating base 102 and the insulating cover 104 are held together by a cantilever snap fit and thereby capture the conductors. The electrical contact base 100 can be held together using the snap fit features until, for example, it is installed for end use, which may be performed using fasteners, such as screws. Such mounting hardware is then insulated by the insulating base 102 and the insulating cover 104.

The insulating base 102 can include hooks 108 on opposing sides of the base that deflect and then catch on ledges 110 defined by the mating insulating cover 104. In some embodiments, the insulating base 102 can define a lattice support structure 112 on an underside of the base, e.g., in the manner of a honeycomb or other shapes with cells that provide high compression and/or shear properties. The lattice support structure 112 may provide rigidity to the electrical contact base 100, prevent warping of the shell assembly 106, and so forth.

The electrical contact base 100 also includes one or more electrical contacts or bus bars 114 captured between the insulating base 102 and the insulating cover 104. A bus bar 114 can be formed from an electrically conductive material, such as copper. In embodiments, each bus bar 114 has a contact plate 116 and an integrally connected end tab 118. In some embodiments, the end tab 118 of a bus bar 114 may define an incline for guiding the brush of a vehicle onto the electrical contact base 100 and into contact with the contact plate 116. For example, the end tab 118 is bent at an angle from the contact plate 116 so that the brush of a vehicle contacts the end tab 118 midway between the end of the end tab 118 and the contact plate 116. In some embodiments, the bus bar 114 can also include a second end tab 118 integrally connected to the contact plate 116 (e.g., opposite the first end tab 118). The second end tab 118 can define another incline (e.g., opposite the first incline) for guiding a brush of the vehicle onto the electrical contact base 100 and into contact with the contact plate 116. However, an end tab 118 defining an incline is provided by way of example and is not meant to limit the present disclosure. In other embodiments, an end tab 118 may extend in at least substantially the same plane as the contact plate 116. In this example, the contact plate 116 and the end tab(s) 118 may form a substantially flat plate, and the collector or brush of a vehicle may be lowered onto the plate after the collector is positioned. For example, the brush can be mechanically lowered from the vehicle onto a flat plate using a linear actuator or another actuation mechanism.

In some embodiments, the electrical contact base 100 includes two (2) bus bars 114, e.g., in a side-by-side configuration. However, two (2) bus bars 114 are provided by way of example and are not meant to limit the present disclosure. In other embodiments, more or fewer than two (2) bus bars 114 may be included with an electrical contact base 100. The first and/or second end tabs 118 of the bus bars 114 can be free of (e.g., not captured by) the shell assembly 106. In this manner, the ends can float to allow for manufacturing deviations in the insulating base 102 and/or the insulating cover 104. In some embodiments, the end tabs 118 can be shorter than the receiving openings formed for the tabs in the insulating cover 104. In this manner, the end tabs 118 may be less likely to interfere with automated assembly processes, such as robotic assembly.

In addition to the contact plate 116 and the end tab(s) 118, a bus bar 114 can also include one or more power feed tabs 120, integrally formed with the bus bar 114 and connected to the contact plate 116. By including a power feed tab 120 with the contact plate 116, the total electrical resistance of the bus bar 114 can be reduced, e.g., by eliminating bolted, welded, or otherwise fastened connection points. The reduced electrical resistance across the contact plate 116 provided by the electrical contact base 100 can increase the efficiency of electrical charging systems incorporating the electrical contact base 100 and reduce resistance heating of such systems. In this manner, the electrical contact bases 100 described herein can be used in place of typical charging bases, which implement threaded fastening to secure copper contacts to a polymer insulator, and copper plates to a bus bar for electrical connection. Examples of these typical implementations include countersunk screws, which produce a non-continuous surface, and welded studs. In these typical implementations, the fastened connection points have more points of contact resistance, resulting in greater voltage drops across such devices.

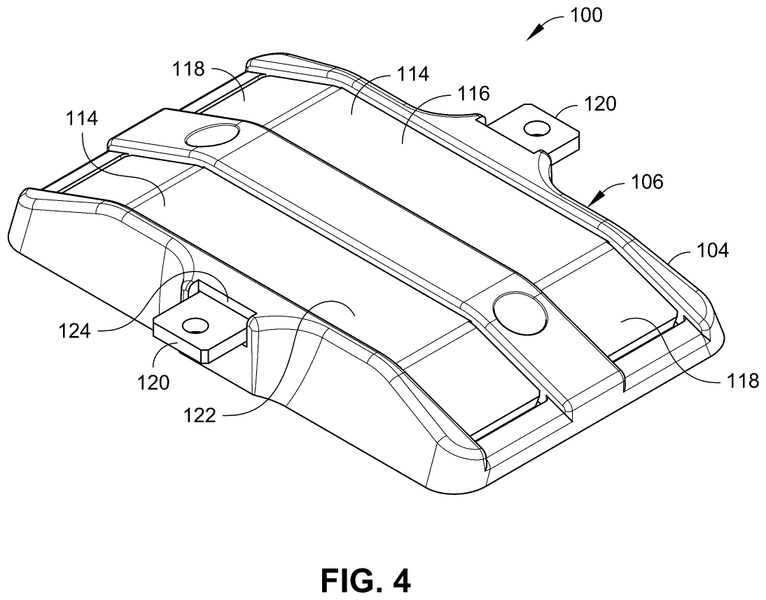

In embodiments of the disclosure, the insulating cover 104 protrudes above a top surface 122 of the contact plate 116 of the bus bar 114. This arrangement can prevent incidental contact between the contact plate 116 and items in the vicinity of the electrical contact base 100. For example, if a wrench falls on the electrical contact base 100, the protruding insulating cover 104 can prevent the wrench from completing a circuit and electrically shorting adjacent bus bars 114. In some embodiments, the power feed tabs 120 can be directed downwardly from the electrical contact base 100 (e.g., as shown in FIGS. 1 through 3). In some embodiments, the insulating cover 104 can define one or more slots 124 for the power feed tabs 120. In these examples, the power feed tabs 120 can be directed outwardly from the electrical contact base 100 through the slots 124 (e.g., as shown in FIGS. 4 through 6). The power feed tabs 120 can also be positioned at an angle from the electrical contact base 100 (e.g., at a forty-five (45) degree angle from the horizontal).

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An electrical contact base for charging a vehicle, the vehicle configured to contact the electrical contact base for charging the vehicle, the electrical contact base comprising:
an insulating base;
an insulating cover connected to the insulating base;
a first bus bar captured between the insulating base and the insulating cover, the first bus bar having a first contact plate and an integrally connected first end tab for guiding a brush of a vehicle onto the electrical contact base and into contact with the first contact plate; and
a second bus bar captured between the insulating base and the insulating cover adjacent to the first bus bar, the second bus bar having a second contact plate and an integrally connected second end tab for guiding a brush of the vehicle onto the electrical contact base and into contact with the second contact plate.

2. The electrical contact base as recited in claim 1, wherein at least one of the first end tab or the second end tab defines an incline for guiding the brush of the vehicle onto the electrical contact base and into contact with the at least one of the first contact plate or the second contact plate, respectively.

3. The electrical contact base as recited in claim 1, wherein the insulating base and the insulating cover are formed of polymer insulator material.

4. The electrical contact base as recited in claim 1, wherein the insulating base and the insulating cover are connected by a snap-fit connection.

5. The electrical contact base as recited in claim 1, wherein the insulating base defines a lattice support structure.

6. The electrical contact base as recited in claim 1, wherein at least one of the first bus bar or the second bus bar includes a third end tab integrally connected to the at least one of the first contact plate or the second contact plate, respectively, opposite the at least one of the first end tab or the second end tab for guiding the brush of the vehicle onto the electrical contact base and into contact with the at least one of the first contact plate or the second contact plate, respectively.

7. The electrical contact base as recited in claim 1, wherein the insulating cover protrudes above a top surface of at least one of the first contact plate of the first bus bar or the second contact plate of the second bus bar.

8. An electrical contact base for charging a vehicle, the vehicle configured to contact the electrical contact base for charging the vehicle, the electrical contact base comprising:
an insulating base;
an insulating cover connected to the insulating base; and
a bus bar captured between the insulating base and the insulating cover, the bus bar having a contact plate and an integrally connected end tab, the end tab defining an incline for guiding a brush of a vehicle onto the electrical contact base and into contact with the contact plate.

9. The electrical contact base as recited in claim 8, wherein the insulating base and the insulating cover are formed of polymer insulator material.

10. The electrical contact base as recited in claim 8, wherein the insulating base and the insulating cover are connected by a snap-fit connection.

11. The electrical contact base as recited in claim 8, wherein the insulating base defines a lattice support structure.

12. The electrical contact base as recited in claim 8, wherein the bus bar includes a second end tab integrally connected to the contact plate opposite the first end tab for guiding the brush of the vehicle onto the electrical contact base and into contact with the contact plate.

13. The electrical contact base as recited in claim 8, further comprising a second bus bar captured between the insulating base and the insulating cover adjacent to the first bus bar, the second bus bar having a second contact plate and an integrally connected second end tab for guiding a brush of the vehicle onto the electrical contact base and into contact with the second contact plate.

14. The electrical contact base as recited in claim 8, wherein the insulating cover protrudes above a top surface of the contact plate of the bus bar.

15. An electrical contact base for charging a vehicle, the vehicle configured to contact the electrical contact base for charging the vehicle, the electrical contact base comprising:
an insulating base;
an insulating cover connected to the insulating base; and
a bus bar captured between the insulating base and the insulating cover, the bus bar having a contact plate and an integrally connected end tab for guiding a brush of a vehicle onto the electrical contact base and into contact with the contact plate.

16. The electrical contact base as recited in claim 15, wherein the end tab defines an incline for guiding the brush of the vehicle onto the electrical contact base and into contact with the contact plate.

17. The electrical contact base as recited in claim 15, wherein the insulating base and the insulating cover are formed of polymer insulator material.

18. The electrical contact base as recited in claim 15, wherein the insulating base and the insulating cover are connected by a snap-fit connection.

19. The electrical contact base as recited in claim 15, wherein the insulating base defines a lattice support structure.

20. The electrical contact base as recited in claim 15, wherein the insulating cover protrudes above a top surface of the contact plate of the bus bar.
